(19) United States
(12) Patent Application Publication
(10) Pub. No.: US 2009/0284446 A1
(43) Pub. Date: Nov. 19, 2009

(54) PLASMA DISPLAY DEVICE AND PLASMA-DISPLAY-PANEL DRIVING METHOD

(75) Inventors: Takahiko Origuchi, Osaka (JP); Hidehiko Shoji, Osaka (JP); Mitsuo Ueda, Hyogo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 12/092,188

(22) PCT Filed: Jul. 6, 2007
(86) PCT No.: PCT/JP2007/063558

§ 371 Date: Apr. 30, 2008

(30) Foreign Application Priority Data
Jul. 14, 2006 (JP) 2006-193824

(51) Int. Cl. G09G 3/28

(52) U.S. Cl. 345/60

(57) ABSTRACT

A plasma display device includes a plasma display panel that has plural scan electrodes and plural sustain electrodes constituting display electrode pairs; and a sustain pulse generating circuit that divides a field period into a plurality of sub fields having an initializing period, an address period, and a sustain period and that generates the sustain pulse with a variable rising slope. The sustain pulse generating circuit generates at least two kinds of sustain pulses in which the rising slope of one sustain pulse is steeper than that of the other sustain pulse in the sustain period of at least one sub field of the plural sub fields and applies the sustain pulse having the steeper rising slope to one electrode of each display electrode pair continuously twice or more at the end of the sustain period.

This application is a U.S. National Phase Application of PCT International Application PCT/JP2007/063558.

### TECHNICAL FIELD

The present invention relates to a plasma display device used in a wall-mounted television or a large-scaled monitor and a plasma-display-panel driving method.

### BACKGROUND ART

In an AC surface discharge panel representative of a plasma display panel (hereinafter, simply referred to as “panel”), plural discharge cells are formed between a front substrate and a rear substrate opposed to each other. In the front substrate, plural display electrode pairs each including a scan electrode and a sustain electrode are formed on a front glass substrate so as to be parallel to each other and a dielectric layer and a protective layer are formed to cover the display electrode pairs. In the rear substrate, plural parallel data electrodes are formed on a rear glass substrate, a dielectric layer is formed to cover the data electrodes, plural barrier ribs are formed thereon to be parallel to the data electrodes, and a fluorescent layer is formed on the surface of the dielectric layer and on the side surfaces of the barrier ribs. The front substrate and the rear substrate are opposed to each other so that the display electrode pairs and the data electrodes three-dimensionally intersect each other and are sealed in this state. For example, a discharging gas including 5% of xenon in partial pressure ratio is enclosed in an inner discharge space. Here, discharge cells are formed at positions where the display electrode pairs and the data electrodes are opposed to each other. In the panel having the above-mentioned configuration, ultraviolet rays are generated in the discharge cells by a gaseous discharge and fluorescent substances of red (R), green (G), and blue (B) are excited to emit light by the ultraviolet rays, thereby performing a color display.

As a panel driving method, a sub field method, that is, a method of dividing a field period into plural sub fields and performing a gray scale display by combinations of the sub fields to emit light, is usually used.

Each sub field includes an initializing period, an address period, and a sustain period. In the initializing period, an initializing discharge is generated and wall charges required for a subsequent address operation are formed on the electrodes. An initializing operation includes an initializing operation (hereinafter, referred to as “overall cell initializing operation”) of generating an initializing discharge in all the discharge cells and an initializing operation (hereinafter, referred to as “selective initializing operation”) of generating the initializing discharge in only the discharge cells having generated the sustain discharge.

In the address period, an address discharge is generated to form wall charges by selectively applying an address pulse voltage to the discharge cells to be lighted (hereinafter, also referred to as “addressing”). In the sustain period, a sustain pulse voltage is alternately applied to the display electrode pairs each including a scan electrode and a sustain electrode and a sustain discharge is generated in the discharge cells having generated the address discharge to allow the fluorescent layer of the corresponding discharge cells to emit light, thereby displaying an image.

In this sub field method, the overall cell initializing operation of generating the initializing discharge in all the discharge cells is performed in the initializing period of one sub field among the plural sub fields and the selective initializing operation of generating the initializing discharge in only the discharge cells having generated the sustain discharge is performed in the initializing periods of the other sub fields. Accordingly, the emission of light not associated with a gray scale display can be reduced to the minimum, thereby enhancing a contrast ratio (for example, see Patent Document 1).

A so-called power collecting circuit for reducing power consumption can be generally used as a circuit for applying the sustain pulse to the display electrode pairs (for example, see Patent Document 2). In Patent Document 2, it is noted that each display electrode pair is a capacitive load having inter-electrode capacitance between the display electrode pair. That is, a power collecting circuit is disclosed in the patent document 2 for allowing an inductor and an interelectrode capacitance to resonate in the LC manner by the use of a resonance circuit including the inductor, collecting electric charges accumulated in the interelectrode capacitance by the use of a power collecting capacitor, and reusing the collected electric charges to drive the display electrode pairs.

However, when the discharge cells are reduced in size with the increase in precision of the panel or the partial pressure of xenon is increased to enhance the brightness of the panel, the address discharge gets unstable and the address discharge is not generated in the discharge cells to be lighted, thereby deteriorating image display quality or making a voltage required to generate the address discharge higher. When the voltage applied to the discharge cells at the time of performing the address operation is increased to stably generate the address discharge, the discharge cells not having generated the address discharge are reduced in wall charges due to the influence of the adjacent discharge cells, thereby making the address operation of the next sub field unstable.

Patent Document 1: Japanese Patent Unexamined Publication No. 2000-242224

Patent Document 2: Japanese Patent Examined Publication No. 7-109542

### DISCLOSURE OF THE INVENTION

A plasma display device according to the invention includes: a plasma display panel that has a plurality of discharge cells each having a display electrode pair of a scan electrode and a sustain electrode, wherein a plurality of sub fields is set in one field period, each of the sub fields having an initializing period for generating an initializing discharge in the discharge cell, an address period for generating an address discharge in the discharge cell and a sustain period for applying a sustain pulse to the display electrode pairs to generate a sustain discharge in the discharge cell; and a sustain pulse generating circuit for generating the sustain pulse with a variable rising slope, wherein the sustain pulse generating circuit generates at least two kinds of sustain pulses having different rising slopes and applies the sustain pulse having the steeper rising slope to one of the display electrode pair continuously twice or more at an end of the sustain period.

As a result, it is possible to generate a stable address discharge without increasing a voltage necessary for the address discharge.

### BRIEF DESCRIPTION OF THE DRAWINGS

FIG. 1 is an exploded perspective view illustrating a structure of a panel according to an embodiment of the invention.

FIG. 2 is a diagram illustrating an arrangement of electrodes in the panel.

FIG. 3 is a diagram schematically illustrating driving voltage waveforms, which show a configuration of sub fields according to an embodiment of the invention.

FIG. 4 is a waveform diagram illustrating driving voltages applied to the electrodes of the panel according to the embodiment of the invention.

FIG. 5 is a waveform diagram schematically illustrating a first sustain pulse and a second sustain pulse according to the embodiment of the invention.

FIG. 6 is a waveform diagram illustrating the first sustain pulse and the second sustain pulse applied to display electrode pairs in a sustain period according to the embodiment of the invention.

FIG. 7 is a diagram illustrating a relation between the second sustain pulse and a scan pulse voltage according to the embodiment of the invention.

FIG. 8 is a diagram illustrating a relation between the numbers of times for applying the second sustain pulse and the scan pulse voltage according to the embodiment of the invention.

FIG. 9 is a diagram illustrating a variation in voltage Ve2 when an application condition of the second sustain pulse is changed according to the embodiment of the invention.

FIG. 10 is a diagram illustrating a variation in scan pulse voltage when a sub field to which the second sustain pulse is applied is changed according to the embodiment of the invention.

FIG. 11 is a circuit block diagram illustrating a driving circuit for driving the panel according to the embodiment of the invention.

FIG. 12 is a circuit diagram illustrating a sustain pulse generating circuit according to the embodiment of the invention.

FIG. 13 is a waveform diagram illustrating the first sustain pulse according to the embodiment of the invention.

FIG. 14 is a waveform diagram of the second sustain pulse according to the embodiment of the invention.

### DESCRIPTION OF REFERENCE NUMERALS AND SIGNS

1: PLASMA DISPLAY DEVICE
10: PANEL
21: FRONT SUBSTRATE
22: SCAN ELECTRODE
23: SUSTAIN ELECTRODE
24, 33: DIELECTRIC LAYER
25: PROTECTIVE LAYER
28: DISPLAY ELECTRODE PAIR
31: REAR SUBSTRATE
32: DATA ELECTRODE
34: BARRIER RIB
35: FLUORESCENT LAYER
51: IMAGE SIGNAL PROCESSING CIRCUIT
52: DATA ELECTRODE DRIVING CIRCUIT
53: SCAN ELECTRODE DRIVING CIRCUIT
54: SUSTAIN ELECTRODE DRIVING CIRCUIT
55: TIMING GENERATING CIRCUIT
100, 200: SUSTAIN PULSE GENERATING CIRCUIT
110, 210: POWER RECOVERY SECTION
120, 220: CLAMP SECTION

Q11, Q12, Q13, Q14, Q21, Q22, Q23, Q24, Q26, Q27, Q28, Q29: SWITCHING ELEMENT
D11, D12, D21, D22: DIODE
C10, C20: CAPACITOR
L10, L20: INDUCTOR
Cp: INTERELECTRODE CAPACITANCE
VE1, VE2, VS: SOURCE VOLTAGE

### PREFERRED EMBODIMENTS FOR CARRYING OUT THE INVENTION

Hereinafter, a plasma display device according to an embodiment of the invention will be described with reference to the drawings.

### Embodiment

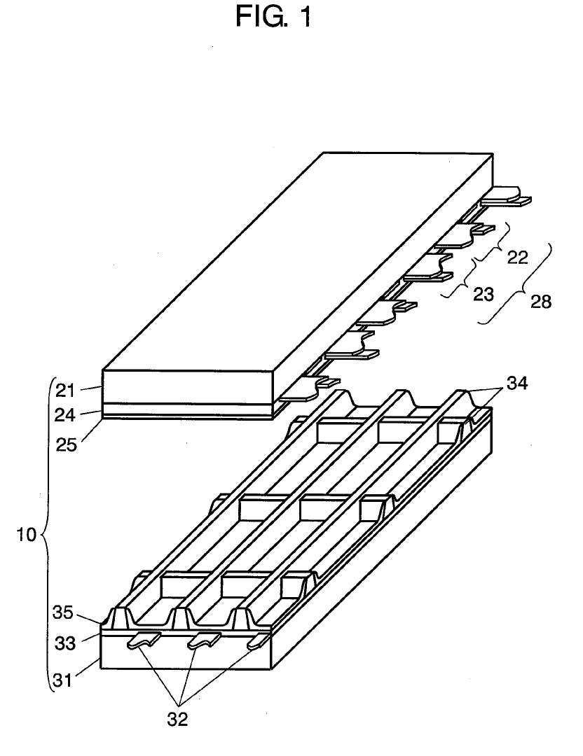

FIG. 1 is an exploded perspective view illustrating a structure of panel 10 according to an embodiment of the invention. Plural Display Electrode Pairs 28 each having scan electrode 22 and sustain electrode 23 are formed on front glass substrate 21. Dielectric layer 24 is formed to cover scan electrodes 22 and sustain electrodes 23 and protective layer 25 is formed on dielectric layer 24. Plural data electrodes 32 are formed on rear substrate 31. Dielectric layer 33 is formed to cover data electrodes 32 and barrier ribs 34 are formed in a grid thereon. Fluorescent layers 35 emitting light of red (R), green (G), and blue (B) are formed on the side surfaces of barrier ribs 34 and on the surfaces of dielectric layer 33.

Front substrate 21 and rear substrate 31 are opposed to each other with a minute discharge space interposed therebetween so that display electrode pairs 28 and data electrodes 32 intersect each other and the outer circumferential portions thereof are sealed with a sealing material such as glass frit. A mixture gas of, for example, neon and xenon is enclosed as a discharging gas in the discharge space. In this embodiment, a discharging gas having about 10% of xenon in partial pressure is used to improve the brightness. The discharge space is partitioned into plural regions by barrier ribs 34 and discharge cells are formed at positions where display electrode pairs 28 and data electrodes 32 intersect each other. The discharge cells generate a discharge and emit light, thereby displaying an image.

The structure of panel 10 is not limited to the above-mentioned structure, but may have, for example, stripe-shaped barrier ribs. The mixing ratio of the discharging gas is not limited to the above-mentioned ratio, but may be any other ratio.

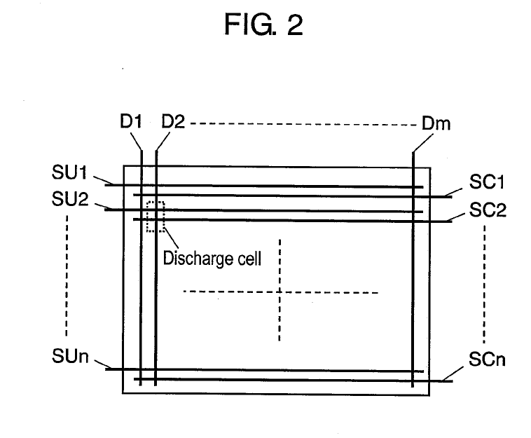

FIG. 2 is a diagram illustrating an arrangement of electrodes of panel 10 according to the embodiment of the invention. In panel 10, n scan electrodes SC1 to SCn (scan electrodes 22 in FIG. 1) and n sustain electrodes SU1 to SUn (sustain electrodes 23 in FIG. 1) which are longitudinal in the row direction are arranged and m data electrodes D1 to Dm (data electrodes 32 in FIG. 1) which are longitudinal in the column direction are arranged. A discharge cell is formed at a position where a pair of scan electrode SCi (i=1 to n) and sustain electrode SUi and one data electrode Dj (j=1 to m) intersect each other and thus m×n discharge cells in total are formed in the discharge space.

Driving voltage waveforms for driving panel 10 and operations thereof will be described now. The plasma display device according to this embodiment performs a gray-scale display by the use of a sub field method, that is, by dividing a field period into plural sub fields and controlling the emission and non-emission of light of the discharge cells by sub fields. Each sub field has an initializing period, an address period, and a sustain period.

In the initializing period, an initializing discharge is generated to form wall charges required for a subsequent address discharge on the electrodes. This initializing operation includes an overall cell initializing operation of generating the initializing discharge in the overall discharge cells and a selective initializing operation of generating the initializing discharge in only the discharge cells having generated the sustain discharge in the previous sub field.

In the address period, the address discharge is selectively generated in the discharge cells which should emit light in the subsequent sustain period, thereby forming wall charges. In the sustain period, sustain pulses the number of which is proportional to a brightness weight are alternately applied to display electrode pairs 28 and the sustain discharge is generated in the discharge cells having generated the address discharge to emit light. Here, the proportional coefficient is called “brightness magnification.”

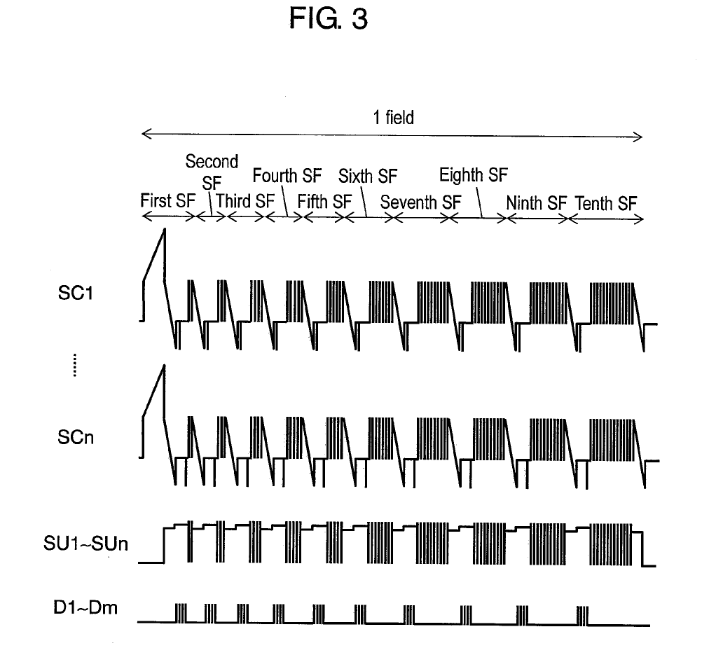

A configuration of sub fields will be described now. FIG. 3 is a schematic driving waveform diagram schematically illustrating the configuration of sub fields according to the embodiment of the invention. FIG. 3 roughly shows driving voltage waveforms of a field in the sub field method and the driving voltage waveforms of the sub fields are described later.

In FIG. 3, the configuration of sub fields is shown in which a field is divided into 10 sub fields (first SF, second SF, . . . , and tenth SF) and the sub fields have brightness weights of, for example, 1, 2, 3, 6, 11, 18, 30, 44, 60, and 80. The overall cell initializing operation is performed in the initializing period of the first SF (hereinafter, a sub field in which the overall cell initializing operation is performed is referred to as “overall cell initializing sub field” in brief) and the selective initializing operation is performed in the initializing periods of the second SF to the tenth SF (hereinafter, a sub field in which the selective initializing operation is performed is referred to as “selective initializing sub field” in brief).

In the sustain periods of the sub fields, the sustain pulses corresponding to the number obtained by multiplying the brightness weights of the sub fields by a predetermined brightness magnification are applied to display electrode pairs 28. However, in this embodiment, the number of sub fields or the brightness weights of the sub fields are not limited to the above-mentioned values, but the configuration of sub fields may be changed on the basis of the image signals or the like.

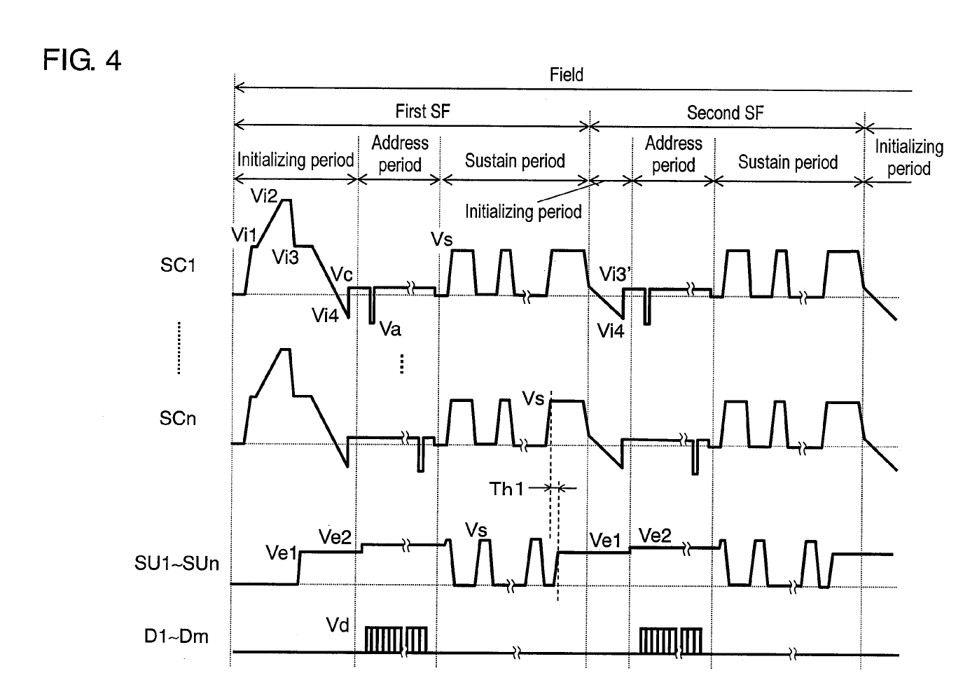

FIG. 4 is a waveform diagram illustrating driving voltages applied to the electrodes of panel 10 according to this embodiment of the invention. FIG. 4 shows driving voltage waveforms of two sub fields, the overall cell initializing sub field, and the selective initializing sub field, but the driving voltage waveforms of the other sub fields are substantially the same.

The first SF which is the overall cell initializing sub field will be first described.

In the first half of the initializing period of the first SF, 0 V is applied to data electrodes D1 to Dm and sustain electrodes SU1 to SUn and a ramp waveform voltage slowly rising from voltage Vi1 which is equal to or smaller than a discharge start voltage for sustain electrodes SU1 to SUn to voltage V12 which is greater than the discharge start voltage is applied to scan electrodes SC1 to SCn.

While the ramp waveform voltage is rising, weak initializing discharge is generated between scan electrodes SC1 to SCn, sustain electrodes SU1 to SUn and data electrodes D1 to Dm. Negative wall voltages are accumulated on scan electrodes SC1 to SCn, and positive wall voltages are accumulated on data electrodes D1 to Dm and sustain electrodes SU1 to SUn. Here, the wall voltages on the electrodes mean voltages resulting from the wall charges accumulated on the dielectric layers, the protective layers, or the fluorescent layers covering the electrodes.

In the second half of the initializing period, positive voltage Ve1 is applied to sustain electrodes SU1 to SUn and a ramp waveform voltage slowly falling from voltage V13 which is equal to or smaller than the discharge start voltage for sustain electrodes SU1 to SUn to voltage V14 greater than the discharge start voltage is applied to scan electrodes SC1 to SCn. In the meantime, weak initializing discharge is generated between scan electrodes SC1 to SCn, sustain electrodes SU1 to SUn and data electrodes D1 to Dm. The negative wall voltage on scan electrodes SC1 to SCn and the positive wall voltage on sustain electrodes SU1 to SUn are weakened, whereby the positive wall voltage on data electrodes D1 to Dm are adjusted to a value suitable for the address operation. In this way, the overall cell initializing operation of generating the initializing discharge in the overall discharge cells is ended.

In the subsequent address period, voltage Ve2 is applied to sustain electrodes SU1 to SUn and voltage Vc is applied to scan electrodes SC1 to SCn.

First, negative scan pulse voltage Va is applied to scan electrode SC1 and in the first row positive address pulse voltage Vd is applied to data electrodes Dk (k=1 to m) of the discharge cells which should be lighted in the first row among data electrodes D1 to Dm. At this time, a voltage difference at an intersection between data electrode Dk and scan electrode Sc1 becomes a voltage obtained by adding a difference between the wall voltage of data electrode Dk and the wall voltage of scan electrode SC1 to externally applied voltage difference (Vd−Va), and thus becomes greater than the discharge start voltage. The address discharge is generated between data electrode Dk and scan electrode SC1 and between sustain electrode SU1 and scan electrode SC1, a positive wall voltage is accumulated on scan electrode SC1, a negative wall voltage is accumulated on sustain electrode SU1, and a negative wall voltage is accumulated on data electrode Dk.

In this way, the address operation of causing the address discharge in the discharge cells which should lighted in the first row and accumulating wall voltages on the electrodes is performed. On the other hand, since voltages of intersections between data electrodes D1 to Dm not supplied with address pulse voltage Vd and scan electrode SC1 do not exceed the discharge start voltage, the address discharge is not generated. The address operation is sequentially performed up to the discharge cells in the n-th row and the address period is finished.

In the subsequent sustain period, positive sustain pulse voltage Vs is applied to scan electrodes SC1 to SCn and 0 V is applied to sustain electrodes SU1 to SUn. Then, in the discharge cells having generated the address discharge in the previous address period, the voltage between scan electrode SCi and sustain electrode SUi becomes a voltage obtained by adding a difference between the wall voltage of scan electrode SCi and the wall voltage of sustain electrode SUi to sustain pulse voltage Vs and thus exceeds the discharge start voltage.

The sustain discharge is generated between scan electrode SCi and sustain electrode SUi and fluorescent layer 35 emits light due to the ultraviolet rays created at that time. A negative wall voltage is accumulated on scan electrode SCi and a positive wall voltage is accumulated on sustain electrode SUi. A positive wall voltage is also accumulated on data electrode Dk. In the discharge cells not having generated the address discharge in the address period, the sustain discharge is not generated and the wall voltage at the end of the initializing period is maintained.

Subsequently, 0 V is applied to scan electrodes SC1 to SCn and sustain pulse voltage Vs is applied to sustain electrodes SU1 to SUn. Then, in the discharge cells having generated the sustain discharge, since the voltage difference between sustain electrode SUi and scan electrode SCi exceeds the discharge start voltage, the sustain discharge is generated again between sustain electrode SUi and scan electrode SCi, whereby a negative wall voltage is accumulated on sustain electrode SUi and a positive wall voltage is accumulated on scan electrode SCi. Similarly, by alternately applying the sustain pulses corresponding to the number obtained by multiplying the brightness weights by the brightness magnification to scan electrodes SC1 to SCn and sustain electrodes SU1 to SUn to cause a potential difference between the electrodes of the display electrode pairs, the sustain discharge is continuously generated in the discharge cells having generated the address discharge in the address period.

At the end of the sustain period, a voltage difference of a so-called narrow pulse shape is applied between scan electrodes SC1 to SCn and sustain electrodes SU1 to SUn by applying voltage Ve1 to sustain electrodes SU1 to SUn in a predetermined time Th1 after applying voltage Vs to scan electrodes SC1 to SCn, and all or a part of the wall voltages on scan electrode SCi and sustain electrode SUi are erased with the positive wall voltage left on data electrode Dk. Specifically, sustain electrodes SU1 to SUn are once returned to 0 V and then sustain pulse voltage Vs is applied to scan electrodes SC1 to SCn. Then, in the discharge cells having generated the sustain discharge, the sustain discharge is generated between sustain electrode SUi and scan electrode SCi. Before the discharge converges, that is, while charge particles created due to the discharge sufficiently remain in the discharge space, voltage Ve1 is applied to sustain electrodes SU1 to SUn. Accordingly, the potential difference between sustain electrode SUi and scan electrode SCi is weakened to (Vs−Ve1). As a result, with positive wall charges left on data electrode Dk, the wall voltages between scan electrodes SC1 to SCn and sustain electrodes SU1 to SUn are weakened to the difference (Vs−Ve1) between voltages applied to the electrodes. Hereinafter, this discharge is referred to as “erasing discharge.”

In this way, after voltage Vs for generating the final sustain discharge, that is, the erasing discharge, is applied to scan electrodes SC1 to SCn, voltage Ve1 for alleviating the potential difference between the electrodes of the display electrode pairs is applied to sustain electrodes SU1 to SUn. In this way, the sustain operation in the sustain period is finished.

Operations in the second SF which is the selective initializing sub field will be described.

In the selective initializing period of the second SF, in a state where voltage Ve1 is applied to sustain electrodes SU1 to SUn and 0 V is applied to data electrodes D1 to Dm, a ramp waveform voltage slowly falling from voltage Vi3′ to voltage V14 is applied to scan electrodes SC1 to SCn.

Then, in the discharge cells having generating the sustain discharge in the sustain period of the previous sub field, a weak initializing discharge is generated and the wall voltages of scan electrode SCi and sustain electrode SUi are weakened. As for data electrode Dk, since the positive wall voltage is sufficiently accumulated on data electrode Dk due to immediately preceding sustain discharge, the excessive wall voltage is discharged and thus the wall voltage is adjusted to be suitable for the address operation.

On the other hand, in the discharge cells not having generated the sustain discharge in the previous sub field, the wall charges at the end of the initializing period of the previous sub field are maintained without being discharged. In this way, the selective initializing operation is an operation of selectively generating the initializing discharge in the discharge cells having performed the sustain operation in the sustain period of the immediately preceding sub field.

Operations of the subsequent address period are similar to operations of the address period of the overall cell initializing sub field and thus will not be described. Operations of the subsequent sustain period are similar, except for the number of sustain pulses.

In this embodiment, in the sustain period, at least two kinds of sustain pulses in which a rising slope of one sustain pulse is steeper than that of the other sustain pulse are generated (hereinafter, the sustain pulse having the steeper rising slope is denoted by a “second sustain pulse” and the other sustain pulse is denoted by a “first sustain pulse”). At the end of the sustain period of a sub field (the fifth SF or later in this embodiment, where the tenth SF which is a sub field just before the first SF as the overall cell initializing sub field is excluded) the brightness weight of which is equal to or greater than a predetermined value (10 in this embodiment), the second sustain pulse is applied to sustain electrodes SC1 to SCn continuously 5 times. Accordingly, it is possible to generate a stable address discharge without increasing a voltage necessary for the address.

Next, a panel driving method according to this embodiment will be described.

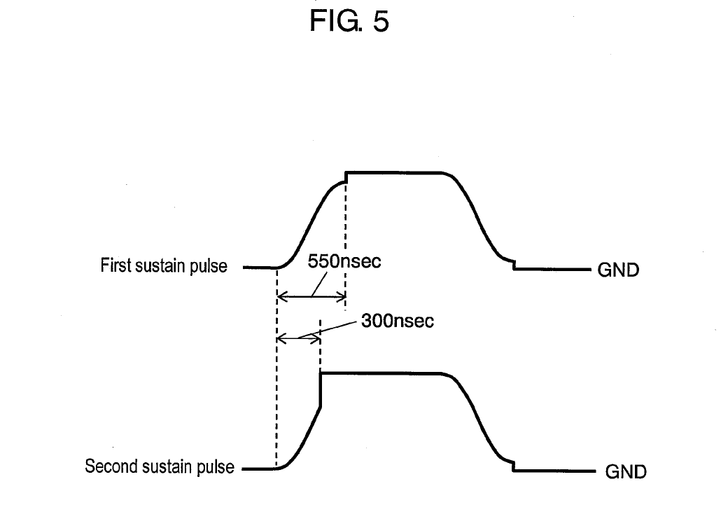

FIG. 5 is a waveform diagram schematically illustrating the first sustain pulse and the second sustain pulse according to the embodiment of the invention. Here, in the description of the sustain pulses, “rising time” and “falling time” mean period for operating power recovery section 110 or power recovery section 210 to be described later so as to allow the sustain pulse to rise or to allow the sustain pulse to fall. The case where the period for operating power recovery section 110 or power recovery section 210 is short is denoted by “fast” and the case where the period is long is denoted by “slow.” In this embodiment, the rising time of the first reference pulse as a reference is about 550 nsec and the rising time of the second sustain pulse is about 300 nsec. Accordingly, the second sustain pulse rises faster than the first sustain pulse. The falling time of the first sustain pulse is equal to the falling time of the second sustain pulse, which are both about 550 nsec.

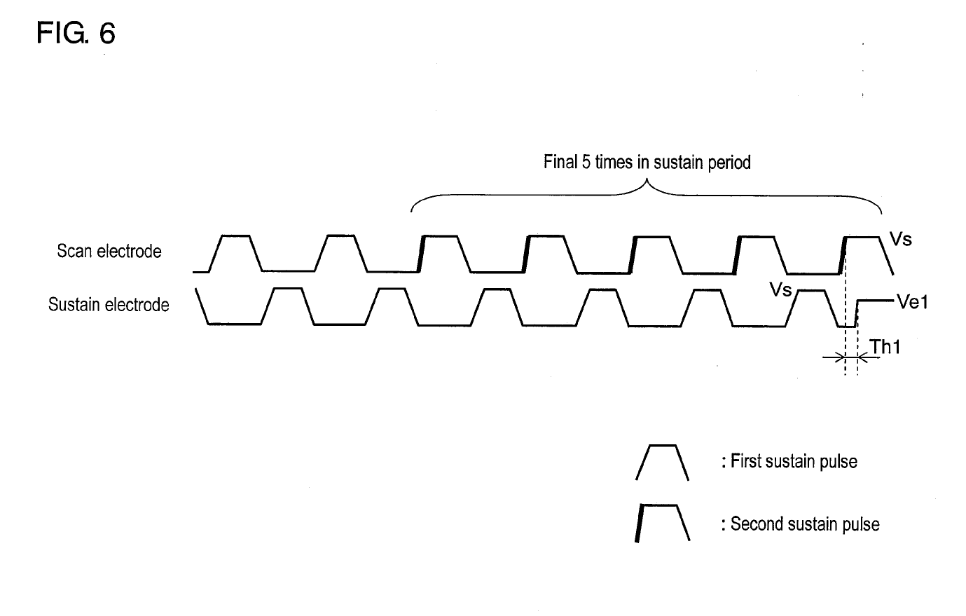

FIG. 6 is a waveform diagram schematically illustrating the first sustain pulse and the second sustain pulse applied to display electrode pairs 28 in the sustain period according to the embodiment of the invention.

In this embodiment, as described above, the first sustain pulse and the second sustain pulse which is faster than the first sustain pulse in rising are generated in the sustain period and are applied to display electrode pairs 28. At this time, as shown in FIG. 6, the second sustain pulse is applied to scan electrodes SC1 to SCn continuously 5 times at the end of the sustain period. A driving circuit for generating the sustain pulses and details of generating the sustain pulses will be described later, but the driving circuit has a power recovery section and a voltage clamping section and controls the rising of the sustain pulses by controlling the driving time of the power recovery section.

In this embodiment, it is possible to generate stable address discharge without increasing a voltage necessary for the address by the use of the panel driving method shown in FIG. 6.

The main reason for making the address discharge unstable is that the wall charges formed in the discharge cells are not sufficient or that the wall charges formed in the discharge cells are not uniform.

The wall charges formed in the sustain period depend on the intensity of the sustain discharge. Accordingly, when weak sustain discharge is generated, wall charges formed in the discharge cells are left insufficient. Alternatively, when the sustain discharge is not uniform in the discharge cells, the wall charges are not uniform in the discharge cells. On the other hand, as described above, the address discharge in the selective initializing sub field depends on the wall charges formed in the sustain period of the previous sub field. That is, the sustain discharge the discharge intensity of which is not sufficient is generated or the sustain discharge is not uniform in the discharge cells, thereby causing the unstable address discharge.

One reason that the sustain discharge the discharge intensity of which is not sufficient or the sustain discharge not uniform in the discharge cells is generated is as follows.

Since a lighting ratio of the discharge cells varies depending on display images, driving loads of the display electrode pairs are different depending on the display images. Here, when impedance of voltage applying means is high, the rising waveform of the sustain pulse is not uniform and the timing (discharge start time) when the discharge is generated in the discharge cells is not uniform.

In a panel in which the partial pressure of xenon is increased to improve emission efficiency, the discharge start voltage between the display electrode pairs increases and thus the non-uniformity in timing for generating the discharge tends to further increase.

In this way, when the timing of generating a discharge varies in the adjacent discharge cells, the discharge intensity is different in the discharge cell having first generated a discharge and the discharge cell having later generated a discharge. This is because the wall charges of the discharge cell later generating a discharge are reduced under the influence of the discharge cell first generating a discharge to weaken the discharge, or the once-started discharge is temporarily stopped and a discharge is generated again with the rising of the applied voltage, thereby weakening the discharge.

In this way, the discharge intensity is not uniform in the discharge cells generating the sustain discharge, and in the discharge cell in which the discharge intensity is weakened, the wall charges formed in the discharge cell is insufficient. This phenomenon is more remarkable as the rising of the sustain pulse is slower. In the high-precision and large-sized panel, since the pulse width of the address pulse voltage is reduced, there is no margin for the discharge delay or the discharge non-uniformity and there is a tendency that the address discharge becomes more unstable.

In order to make the wall charges formed by the sustain discharge as uniform as possible by uniformizing the discharge intensity in the discharge cells, it is effective that the discharge is generated in a state where the variation in voltage is fast. When the discharge is generated in a state where the variation in voltage is fast, the non-uniformity in discharge start voltage can be absorbed and the non-uniformity in timing of generating the discharge between the discharge cells can be reduced. Accordingly, it is possible to reduce the non-uniformity of the discharge intensity and thus to uniformize the wall charges formed by the sustain discharge.

Since the discharge resulting from the fast variation in voltage is strong, it has a function of reducing the non-uniformity in timing of generating the discharge as well as a function of forming sufficient wall charges in the discharge cells.

Therefore, in this embodiment, the second sustain pulse is generated for the purpose of reducing the non-uniformity in timing of generating the discharge and forming the sufficient wall charges in the discharge cells. That is, by generating the second sustain pulse having the rising slope steeper than the first sustain pulse, the discharge is generated in a state where the variation in voltage applied to the panel is fast. Accordingly, the non-uniformity in discharge start voltage is absorbed to uniformize the timing of generating the discharge in the discharge cells, thereby reducing the non-uniformity of the wall charges in the discharge cells and forming the sufficient wall charges in the discharge cells.

As a scan pulse voltage necessary for generating a normal address discharge is lowered, a margin for scan pulse voltage Va actually applied is increased, thereby stably generating the address discharge. Accordingly, the inventor made an experiment on reviewing the rising of the second sustain pulse and the application times thereof, which can reduce the scan pulse voltage necessary for generating the normal address discharge.

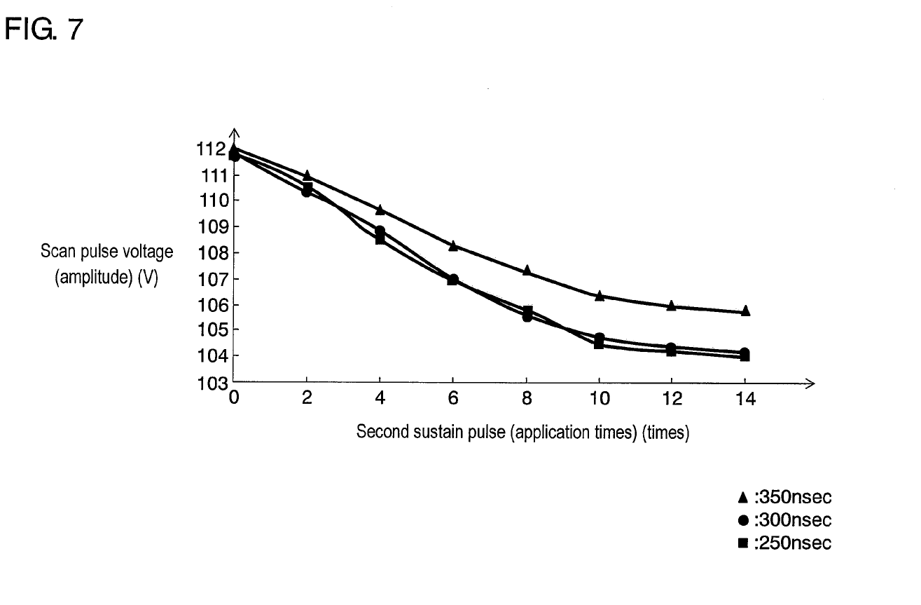

FIG. 7 is a diagram illustrating a relation between the second sustain pulse and the scan pulse voltage according to the embodiment of the invention. In FIG. 7, the horizontal axis represents the number of times for applying the second sustain pulse and the vertical axis represents the scan pulse voltage (hereinafter, referred to as “necessary scan pulse voltage” in brief) necessary for generating the normal address discharge in the address period of the subsequent sub field. In this experiment, it was examined how the necessary scan pulse voltage should vary in the address discharge of the subsequent sub field while changing the number of times for applying the second sustain pulse and the rising time of the second sustain pulse.

In this experiment, by using the driving with the first sustain pulse as a reference and sequentially changing the first sustain pulse into the second sustain pulse, the number of times for applying the second sustain pulse was increased. Since the sustain pulse applied at the end of the sustain period more strongly affects the address discharge in the subsequent sub field, the change from the first sustain pulse to the second sustain pulse was performed sequentially from the last of the sustain period. Accordingly, for example, the number of times “4” for applying the second sustain pulse in FIG. 7 represents that the second sustain pulse is used as the sustain pulse of the last two times in the sustain period among the sustain pulses applied to scan electrodes SC1 to SCn and sustain electrodes SU1 to SUn. The number of times “8” for applying the second sustain pulse represents that the second sustain pulse is used as the sustain pulse of the last four times in the sustain period. The numerical values regarding the application of the second sustain pulse to be mentioned in the following description represent the number of times for applying the sustain pulse from the last of the sustain period.

In this experiment, the sub fields (first SF to fourth SF in this embodiment) having a small brightness weight were excluded from the target to which the second sustain pulse is applied and the sub fields (fifth or later SF in this embodiment) having a brightness weight greater than a predetermined value (10 in this embodiment) were set as the target to which the second sustain pulse is applied. In the initializing period of the overall cell initializing sub field, since the initializing operation is performed in the overall discharge cells to form wall charges in the overall discharge cells, the sub field (tenth SF in this embodiment) just before the overall cell initializing sub field (first SF in this embodiment) was excluded from the target to which the second sustain pulse is applied. Thus, the second sustain pulse is applied at least one of the sub fields which is a sub field other than the final sub field in one field period.

In this experiment, fifth SF to ninth SF were set as the target to which the second sustain pulse is applied and in the sustain periods of the sub fields, the number of times for applying the second sustain pulse was increased by sequentially changing the sustain pulse applied to the display electrode pairs 28 to the second sustain pulse from the last of the sustain period. Then, it was examined how the necessary scan pulse voltage should be changed with the increase in number of times for applying the second sustain pulse. The rising time of the second sustain pulse was changed to three types of 250 nsec, 300 nsec, and 350 nsec and the above-mentioned experiment was made for each rising time. It was also examined how the necessary scan pulse voltage should be changed by changing the rising slope steepness of the second sustain pulse.

In this experiment, a 50-inch panel with 1080 display electrode pairs was used at a panel temperature of 70° C.

The followings became clear this experiment.

First, the necessary scan pulse voltage was reduced as the number of times for applying the second sustain pulses increased. Accordingly, it was found that it is difficult to change the wall-charge state by changing the intensity of the sustain discharge once and it is necessary to continuously generate a strong sustain discharge.

Next, when the tendency slowly reaches the limit and the number of times for applying the second sustain pulse is 10 or more, the effect of reducing the necessary scan pulse voltage was found to become very moderate.

As the rising time of the second sustain pulse decreases, the scan pulse voltage necessary for generating the normal address discharge is lowered. A difference in scan pulse voltage between the rising time of 350 nsec and the rising time of 300 nsec was great, but the difference in scan pulse voltage between the rising time of 300 nsec and the rising time of 250 nsec was small.

When the rising slope of the sustain pulse is made steeper than usual, the driving time of the power recovery section is reduced as much, thereby lowering the power collecting rate and damaging the effect of reducing power consumption. Accordingly, the number of times for generating the second sustain pulse is preferably as gentle as possible and the rising time of the second sustain pulse is preferably as gentle as possible so long as the effect of reducing the necessary scan pulse voltage can be obtained. It could be found from this experiment that it is possible to obtain a sufficient effect by applying the second sustain pulse having a rising time of 300 nsec to scan electrodes SC1 to SCn and sustain electrodes Su1 to SUn 5 times, respectively.

On the other hand, when a strong address discharge is generated in a certain discharge cell, the wall charges are reduced (hereinafter, also referred to as “charge reduction”) in cells not having generated discharge and adjacent to the certain discharge cell, due to the influence of the strong address discharge in the discharge cell. This is remarkable in the panel having fine discharge cells with high precision.

In the sub field in which the selective initializing operation is performed, since the initializing discharge is selectively generated in the discharge cells having performed the sustain operation in the sustain period of the immediately preceding sub field, a discharge is not generated in the discharge cells not having generated the sustain discharge in the immediately preceding sub field and the wall charges in the discharge cells at the end of the initializing period of the immediately preceding sub field are used for the address. Accordingly, when the wall charges in the discharge cells not having emitted light are reduced due to the strong address discharge generated in the adjacent discharge cells, the wall charges necessary for the address in the subsequent sub field in which the selective initializing operation is performed, thereby causing discharge failure at the time of performing the address operation.

Therefore, the inventor carried out an experiment to review whether there is any method of generating a stable address discharge at the time of performing the address operation without weakening the effect of reducing the necessary scan pulse voltage and controlling the discharge intensity of the address discharge so as not to reduce the wall charges in the adjacent discharge cells.

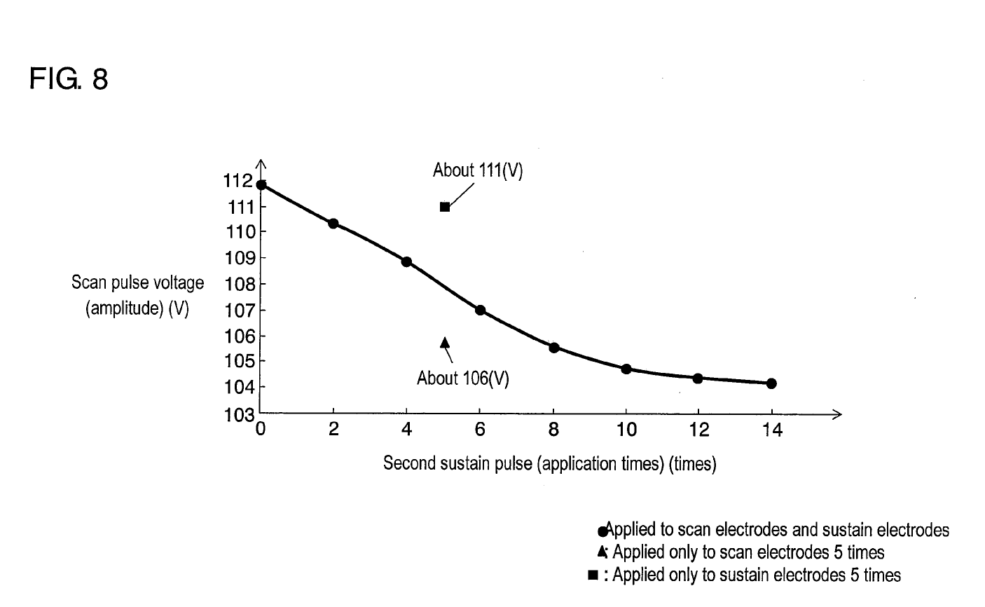

FIG. 8 is a diagram illustrating a relation between the numbers of times for applying the second sustain pulse and the scan pulse voltage according to the embodiment of the invention. In FIG. 8, the horizontal axis represents the number of times for applying the second sustain pulse and the vertical axis represents the necessary scan pulse voltage in the address period of the subsequent sub field.

In this experiment, the difference in necessary scan pulse voltage was compared between when the second sustain pulse is applied to only scan electrodes SC1 to SCn and when the second sustain pulse is applied to only sustain electrodes SU1 to SUn.

In this experiment, the rising time of the second sustain pulse was set to 300 nsec on the basis of the experiment result shown in FIG. 7. Similarly, from the experiment result that a sufficient effect is obtained by applying the second sustain pulse to scan electrodes SC1 to SCn and sustain electrodes SU1 to SUn 5 times, the difference in necessary scan pulse voltage was reviewed between when the second sustain pulse is applied to only scan electrodes SCi to SCn 5 times and when the second sustain pulse is applied to only sustain electrodes SU1 to SUn 5 times.

In this experiment, similarly to the experiment shown in FIG. 7, the sustain periods of the fifth SF to the ninth SF were set as the target to which the second sustain pulse is applied. A panel having the same configuration as the panel used in the experiment of FIG. 7 was used under the same condition. In FIG. 8, a sample in which the rising time of the second sustain pulse is 300 nsec among the experiment result shown in FIG. 7 was also used for comparison with this experiment result.

The following results were obtained from this experiment. As shown in FIG. 8, the necessary scan pulse voltage in the subsequent sub field is about 111 (V) when the second sustain pulse is applied to only sustain electrodes SU1 to SUn and the necessary pulse voltage is about 106 (V) when the second sustain pulse is applied to only scan electrodes SC1 to SCn. A difference of about 5 (V) existed therebetween. As can be seen from FIG. 8, the numerical value of about 106 (V) is almost the same as the reduction effect obtained when the second sustain pulse to scan electrodes SC1 to SCn and sustain electrodes SU1 to SUn 4 times. That is, it was found from this experiment that a sufficient effect could be obtained by only applying the second sustain pulse to scan electrodes SC1 to SCn.

When the sustain pulse voltage applied to scan electrodes SC1 to SCn has the same waveform as the sustain pulse voltage applied to sustain electrodes SU1 to SUn at the time of generating the sustain discharge, the wall chargers formed on scan electrodes SC1 to SCn are almost equal to the wall charges formed on sustain electrodes SU1 to SUn. On the other hand, when the sustain pulse voltage having the steeper rising slope is applied to only one of electrodes of the display electrode pair, more wall charges are accumulated on the electrode to which the sustain pulse voltage having the steeper rising slope.

In the address operation, as described above, a voltage necessary for generating a discharge is applied between scan electrode SCi and data electrode Dk to generate a discharge and a discharge is generated between scan electrodes SC1 to SCn and sustain electrodes SU1 to SUn by using the discharge as a trigger. That is, the address discharge is influenced by the wall charges formed on scan electrodes SC1 to SCn than by the wall charges formed on sustain electrodes SU1 to SUn.

Accordingly, by forming more wall charges on scan electrodes SC1 to SCn, it is possible to enhance the effect of reducing the necessary scan pulse voltage. That is, even when the second sustain pulse is applied to only scan electrodes SC1 to SCn, the wall charges formed on scan electrodes SC1 to SCn are enough to influence the generation of the address discharge, thereby satisfactorily reducing the necessary scan pulse voltage.

On the other hand, the wall charges formed on sustain electrodes SU1 to SUn influence the discharge generated between scan electrodes SC1 to SCn and sustain electrodes SU1 to SUn at the time of generating the address discharge. That is, the wall charges influences more the increase of the discharge intensity than the effect of reducing the necessary scan pulse voltage. Accordingly, when the second sustain pulse is not applied to sustain electrodes SU1 to SUn, it is possible to expect an effect of controlling the wall charges formed on sustain electrodes SU1 to SUn and reducing the discharge intensity of the address discharge.

Therefore, the inventor made an experiment on reviewing to what extent the address failure resulting from the charge reduction is improved when the second sustain pulse is applied to only scan electrodes SC1 to SCn.

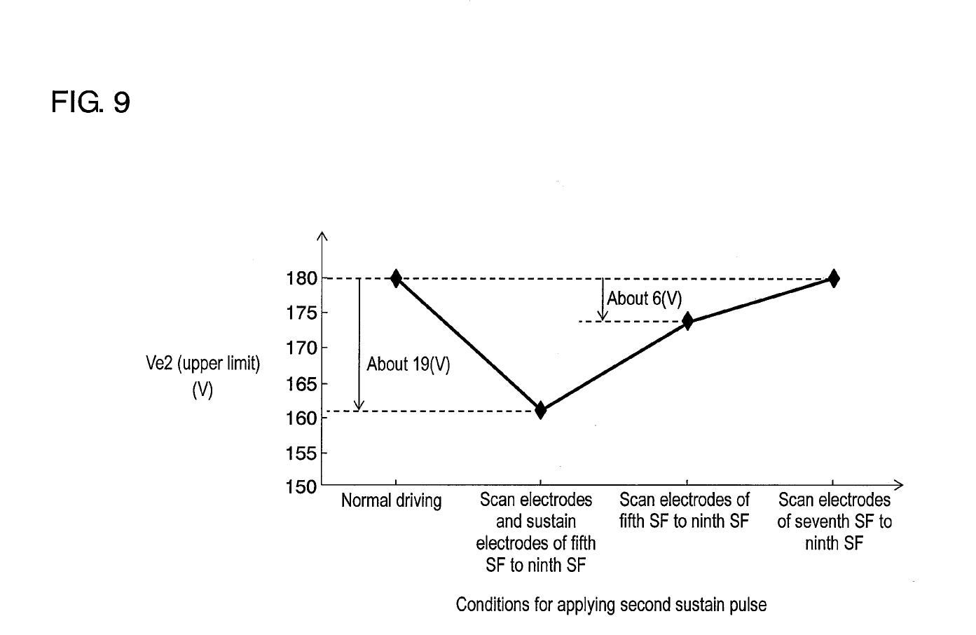

FIG. 9 is a diagram illustrating a variation in voltage Ve2 when the application condition for the second sustain pulse is changed according to the embodiment of the invention. In FIG. 9, the horizontal axis represents the application condition for the second sustain pulse and the vertical axis represents the upper limit of voltage Ve2 with which the address failure due to the charge reduction is not generated in the address period of the subsequent sub field. In this experiment, it was examined how voltage Ve2 with which the address failure due to the charge reduction is not generated in the address period of the subsequent sub field is changed while changing the application condition for the second sustain pulse.

At the time of performing the address operation, the voltage applied to the discharge cells increases as voltage Ve2 applied to sustain electrodes SU1 to SUn increases, whereby the address discharge is stably generated. On the other hand, the address discharge is more strongly generated as voltage Ve2 gets greater, and the charge reduction is easily generated. On the contrary, when voltage Ve2 applied to sustain electrodes SU1 to SUn is lowered, the discharge intensity of the address discharge is weakened and the charge reduction is unlikely generated but the discharge becomes unstable. Voltage Ve2 shown in FIG. 9 represents the upper limit of voltage Ve2 applied to the discharge cells not causing the charge reduction. When voltage Ve2 is low, the charge reduction is easily generated. Accordingly, the voltage applied to the discharge cells is not enhanced and thus the address discharge easily becomes unstable. On the contrary, when voltage Ve2 is high, the charge reduction is unlikely generated. Accordingly, it is possible to enhance the voltage applied to the discharge cells, thereby generating a stable address discharge.

In this experiment, the panel was driven under 4 different conditions of a normal driving (driving using only the first sustain pulse), when the second sustain pulse is applied to scan electrodes SC1 to SCn and sustain electrodes SU1 to SUn 5 times in the address periods of the fifth SF to the ninth SF, when the second sustain pulse is applied to only scan electrodes SC1 to SCn 5 times in the address periods of the fifth SF to the ninth SF, and when the second sustain pulse is applied to only scan electrodes SC1 to SCn 5 times in the address periods of the seventh SF to the ninth SF. By examining the address failure due to the charge reduction while slowly increasing voltage Ve2 in the respective driving conditions, the upper limit of voltage Ve2 not causing the charge reduction was examined.

In this experiment, similarly to the experiment shown in FIG. 8, the rising time of the second sustain pulse was set to 300 nsec. A panel having the same configuration as the panel used in FIGS. 7 and 8 was used under the same conditions.

As a result, voltage Ve2 not causing the address failure due to the charge reduction was about 180 (V) in the normal driving using only the first sustain pulse. When the second sustain pulse is applied to scan electrodes SC1 to SCn and sustain electrodes SU1 to SUn 5 times in the address periods of the fifth SF to the ninth SF, the voltage was about 161 (V) and was lower by 19 (V) than that of the normal driving. This means that the charge reduction can be easily generated as much. Accordingly, when the second sustain pulse is applied to scan electrodes SC1 to SCn and sustain electrodes SU1 to SUn, it became clear that the charge reduction can be easily generated while reducing the necessary scan pulse voltage.

On the other hand, similarly to the experiment shown in FIG. 8, when the second sustain pulse is applied to only scan electrodes SC1 to SCn 5 times in the address periods of the fifth SF to the ninth SF, voltage Ve2 not causing the address failure due to the charge reduction was about 174 (V) and was lower only by about 6 (V) than that of the normal driving. That is, it was confirmed that when the second sustain pulse is applied to only scan electrodes SC1 to SCn, the above-mentioned effect, that is, the effect of reducing the necessary scan pulse voltage and lowering the discharge intensity of the address discharge to prevent the charge reduction, can be obtained.

When the sub fields to which the second sustain pulse is applied is further restricted and thus the second sustain pulse is applied to only scan electrodes SC1 to SCn 5 times in the address periods of the seventh SF to the ninth SF, voltage Ve2 not causing the address failure due to the charge reduction was about 180 (V) and was almost equal to that of the normal driving.

Therefore, the inventor made an experiment on reviewing how the necessary pulse voltage should vary, when the condition that the second sustain pulse is applied to only scan electrodes SC1 to SCn 5 times was common and the sub fields to which the second sustain pulse is applied are changed.

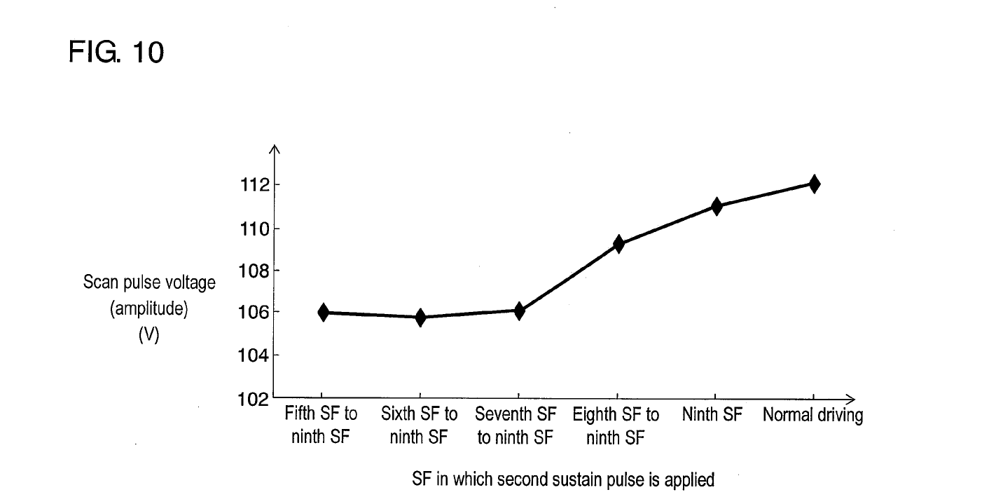

FIG. 10 is a diagram illustrating a variation in scan pulse voltage when the sub fields to which the second sustain pulse is applied are changed according to the embodiment of the invention. In FIG. 10, the horizontal axis represents the sub field to which the second sustain pulse is applied and the vertical axis represents the necessary scan pulse voltage in the address period of the subsequent sub field. In this experiment, it was reviewed how the necessary scan pulse voltage varies in the address discharge of the subsequent sub field while changing the sub fields to which the second sustain pulse is applied in the fifth SF to the ninth SF.

In this experiment, similarly to the experiments shown in FIGS. 8 and 9, the rising time of the second sustain pulse was set to 300 nsec. A panel having the same configuration as the panel used in FIGS. 7 to 9 was used under the same condition. Similarly to the experiment shown in FIG. 7, the tenth SF which is a sub field just before the overall cell initializing sub field (the first SF in this embodiment) was excluded from the target to which the second sustain pulse is applied.

In this experiment, the panel was driven under six different conditions of when the target sub field to which the second sustain pulse is applied is set to the fifth SF to the ninth SF, when the target sub field to which the second sustain pulse is applied is set to the sixth SF to the ninth SF, when the target sub field to which the second sustain pulse is applied is set to the seventh SF to the ninth SF, when the target sub field to which the second sustain pulse is applied is set to the eighth SF to the ninth SF, when the target sub field to which the second sustain pulse is applied is set to only the ninth SF, and the normal driving using only the first sustain pulse.

As a result, as shown in FIG. 10, the necessary scan pulse voltage did not vary when the target sub field to which the second sustain pulse is applied is set to the fifth SF to the ninth SF, when the target sub field to which the second sustain pulse is applied is set to the sixth SF to the ninth SF, and when the second sustain pulse is applied in the seventh SF to the ninth SF. As the number of sub fields to which the second sustain pulse is applied is decreased, it was found that the necessary scan pulse voltage is increased.

Accordingly, from the results shown in FIGS. 9 and 10, it could be known that the best effect can be obtained by setting the target sub field to which the second sustain pulse is applied to the seventh SF to the ninth SF.

As described above, in this embodiment, the second sustain pulse having the steeper rising slope is applied to only one of electrodes of the display electrode pair continuously a predetermined number of times at the end of the sustain periods of predetermined sub fields. For example, the second sustain pulse having a rising time of about 300 nsec is applied to scan electrodes SC1 to SCn continuously 5 times at the end of the sustain periods of the seventh SF to the ninth SF. Accordingly, a strong sustain discharge is generated at the end of the sustain period to form sufficient wall charges in the discharge cells. In the address period of the subsequent sub field, the address discharge can be stably generated without increasing the voltage necessary for the address and the discharge intensity can be suppressed so as not to cause the address failure due to the charge reduction in the adjacent discharge cells.

The above-mentioned numerical values depend on the characteristics of the panel and the sub field configuration used in the experiments and do not limit the invention at all. It is preferable that the numerical values can be set to the optimal values depending on the characteristics of the panel, or the sub field configuration, or specifications of the plasma display device. Thus, the sustain pulse generating circuit applies the sustain pulse having the steeper rising slope to only one of electrodes of the display electrode pair continuously twice or more at the end of the sustain period in at least one sub field of the plurality of sub fields.

Next, a circuit configuration of the plasma display device according to this embodiment will be described.

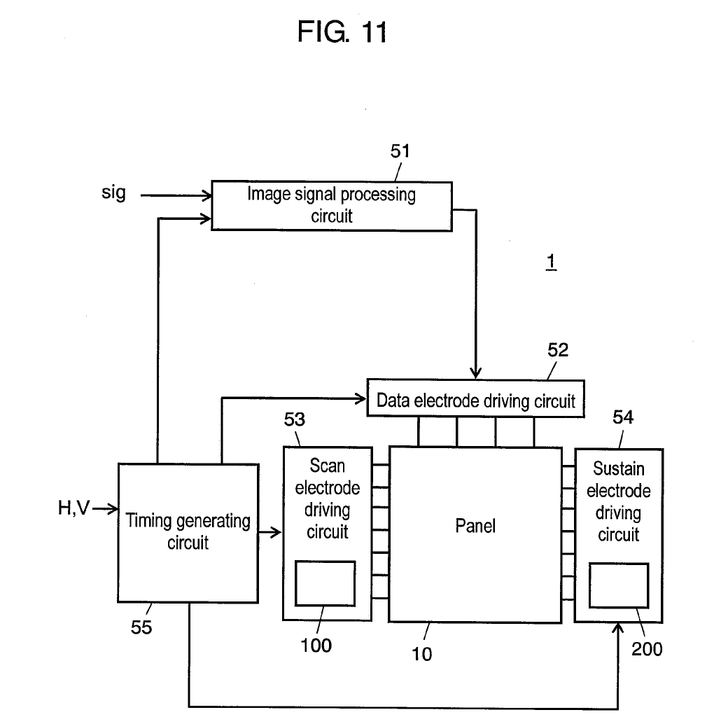

FIG. 11 is a circuit block diagram illustrating a driving circuit for driving a panel according to the embodiment of the invention. Plasma display device 1 includes panel 10, image signal processing circuit 51, data electrode driving circuit 52, scan electrode driving circuit 53, sustain electrode driving circuit 54, timing generating circuit 55, and a power supply circuit (not shown) for supplying power to the circuit blocks.

Image signal processing circuit 51 converts input image signal sig into image data indicating emission or non-emission of light for every sub field. Data electrode driving circuit 52 converts the image data of each sub field into signals corresponding to data electrodes D1 to Dm and drives data electrodes D1 to Dm.

Timing generating circuit 55 generates various timing signals for controlling operations of the circuit blocks on the basis of a horizontal synchronization signal H and a vertical synchronization signal V and supplies the generated timing signals to the circuit blocks. As described above, in this embodiment, two kinds of sustain pulses applied to scan electrodes SC1 to SCn sustain electrodes SU1 to SUn in the sustain period are generated and the timing signals corresponding thereto are output to scan electrode driving circuit 53 and sustain electrode driving circuit 54. Accordingly, it is possible to control the address operation to be stable.

Scan electrode driving circuit 53 includes sustain pulse generating circuit 100 for generating a sustain pulse which is applied to scan electrodes SC1 to SCn in the sustain period and drives scan electrodes SC1 to SCn on the basis of the timing signals. Sustain electrode driving circuit 54 includes a circuit for applying voltage Ve1 to sustain electrodes SU1 to SUn in the initializing period, a circuit for applying voltage Ve2 to sustain electrodes Su1 to SUn in the address period, and sustain pulse generating circuit 200 for generating a sustain pulse which is applied to sustain electrodes SU1 to SUn in the sustain period and drives sustain electrodes SU1 to SUn on the basis of the timing signals.

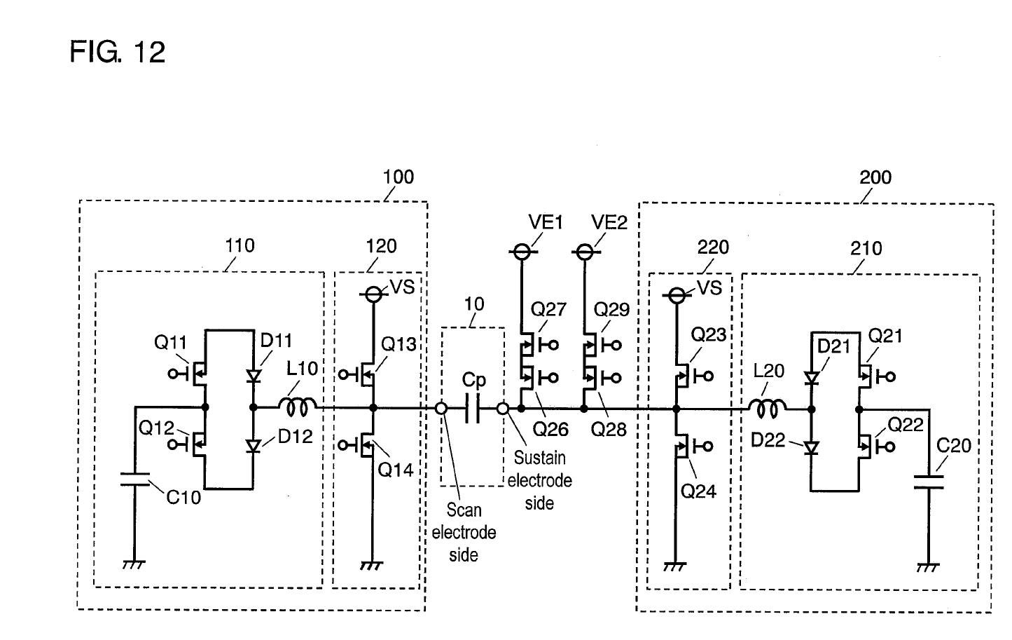

Next, details and operations of sustain pulse generating circuit 100 and sustain pulse generating circuit 200 will be described. FIG. 12 is a circuit diagram illustrating sustain pulse generating circuit 100 and sustain pulse generating circuit 200 according to the embodiment of the invention. In FIG. 12, an interelectrode capacitance of panel 10 is denoted by Cp and circuits for generating the scan pulse and the initializing voltage waveform are omitted.

Sustain pulse generating circuit 100 includes power recovery section 110 and clamp section 120.

Power recovery section 110 includes power collecting capacitor C10, switching elements Q11 and Q12, reverse-current preventing diode D11, diode D12, and resonating inductor L10. Clamp section 120 includes switching element Q13 for clamping scan electrodes SC1 to SCn to power source VS with a voltage value of Vs and switching element Q14 for clamping scan electrodes SC1 to SCn to a ground potential. Power recovery section 110 and clamp section 120 are connected to scan electrodes SC1 to SCn which are an end of interelectrode capacitance Cp of panel 10 through a scan pulse generating circuit (not shown since it is short-circuited in the sustain period).

Power recovery section 110 allows interelectrode capacitance Cp and inductor L10 to resonate in an LC resonating manner so as to raise and lower the sustain pulse. When the sustain pulse rises, the charges accumulated in power collecting capacitor C10 are made to move to interelectrode capacitance Cp through switching element Q11, diode D11, and inductor L10. When the sustain pulse falls, the charges accumulated in interelectrode capacitance Cp are made to return to power collecting capacitor C10 through inductor L10, diode D12, and switching element Q12. In this way, the sustain pulse is applied to scan electrodes SC1 to SCn. Since power recovery section 110 drives scan electrodes SC1 to SCn by the use of the LC resonance without any supply of power from the power source, power consumption is ideally 0. Power collecting capacitor C10 has sufficiently greater capacitance than that of interelectrode capacitance Cp and is charged with about Vs/2 which is a half of the voltage value Vs of power source VS so as to serve as a power source of power recovery section 110.

Voltage clamp section 120 connects scan electrodes SC1 to SCn to power source VS through switching element Q13 to clamp scan electrodes SC1 to SCn to voltage Vs and connects scan electrodes SC1 to SCn to the ground potential through switching element Q14 to clamp the scan electrodes to 0 (V). Voltage clamp section 120 drives scan electrodes SC1 to SCn in this way. Accordingly, impedance at the time of applying a voltage to voltage clamp circuit 120 is small thus it is possible to allow large discharge current due to a strong sustain discharge to stably flow.

In this way, by controlling switching element Q11, switching element Q12, switching element Q13, and switching element Q14, sustain pulse generating circuit 100 applies the sustain pulse to scan electrodes SC1 to SCn by the use of power recovery section 110 and voltage clamp section 120. The switching elements can be constructed by generally known elements such as MOSFET or IGBT.

Sustain pulse generating circuit 200 includes power recovery section 210 having power collecting capacitor C20, switching element Q21, switching element Q22, reverse-current preventing diodes D21, diode D22, and resonating inductor L20 and clamp section 220 having switching element Q23 for clamping sustain electrodes SU1 to SUn to voltage Vs and switching element Q24 for clamping sustain electrodes SU1 to SUn to the ground potential and is connected to sustain electrodes SU1 to SUn which are an end of inter-electrodes capacitor Cp of panel 10. The operations of sustain pulse generating circuit 200 is the same as sustain pulse generating circuit 100 and thus its description will be omitted.

In FIG. 12, power source VE1 for generating voltage Ve1 for reducing the inter-electrode potential difference of the display electrode pairs, power source VE2 for generating voltage Ve2, switching element Q26 and switching element Q27 for applying voltage Ve1 to sustain electrodes SU1 to SUn, and switching element Q28 and switching element Q29 for applying voltage Ve2 to sustain electrodes SU1 to SUn are shown together.

The LC resonance period of inductor L10 of power recovery section 110 and interelectrode capacitance Cp of panel 10 and the LC resonance period (hereinafter, referred to as “resonance period”) of inductor L20 of power recovery section 210 and interelectrode capacitance Cp can be calculated from “2π(LCp)^{1/2}” when it is assumed that inductance of inductor L10 and inductance of inductor L20 are L. In this embodiment, inductor L10 and inductor L20 are set so that the resonance period of power recovery section 110 and power recovery section 210 is about 1100 nsec.

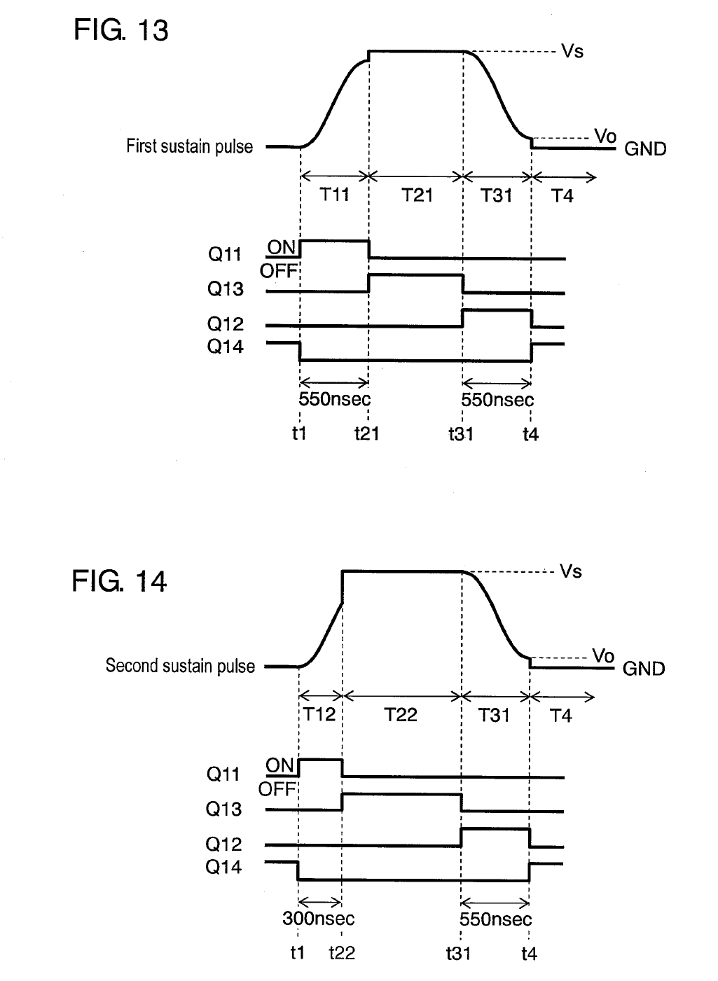

Next, operations of the sustain pulse generating circuit for generating the first sustain pulse and the second sustain pulse will be described with reference to FIGS. 13 and 14.

First, the first sustain pulse as a reference pulse will be described. FIG. 13 is a waveform diagram illustrating the first sustain pulse according to the embodiment of the invention. Here, sustain pulse generating circuit 100 on scan electrode SC1 to SCn side will be described, but sustain pulse generating circuit 200 on sustain electrodes SU1 to SUn side have the same circuit configuration and operations thereof are substantially the same. In the following description on operations of the switching elements, the turning-on operation is denoted by “ON” and the turning-off operation is denoted by “OFF.”

(Period T11)

At time to, switching element Q11 is turned on. Then, charges start moving from power collecting capacitor C10 to scan electrodes SC1 to SCn through, switching element Q11, diode D11, and inductor L10 and thus the voltage of scan electrodes SC1 to SCn starts rising up. Since inductor L10 and interelectrode capacitance Cp form a resonance circuit, the voltage of scan electrodes SC1 to SCn goes up to the vicinity of Vs at the time when about ½ of the resonance period passes from time t1. As described above, in this embodiment, the resonance period of inductor L10 and interelectrode capacitance Cp is set to about 1100 nsec. In the first sustain pulse, the rising time of the sustain pulse applied to scan electrodes SC1 to SCn, that is, period T11 from time to to time t21, is set to about 550 nsec which is ½ of the resonance period.

(Period T21)

At time t21 when about ½ of the resonance period passes from time to, switching element Q13 is turned on.

Then, since scan electrodes SC1 to SCn are connected to power source VS through switching element Q13, scan electrodes SC1 to SCn are clamped to voltage Vs. When scan electrodes SC1 to SCn are clamped to voltage Vs, the voltage difference between scan electrodes SC1 to SCn and sustain electrodes SU1 to SUn exceeds the discharge start voltage and the sustain discharge is generated in the discharge cells having generated the address discharge. When the clamping period to power source VS is too short, the wall charges formed with the sustain discharge are not sufficient, thereby not continuously generating the sustain discharge. On the contrary, when the clamping period is too long, the repetition period of the sustain pulse increases, thereby not applying the necessary number of sustain pulses to the display electrode pairs. Accordingly, it is preferable from the practical point of view that the clamping period to power source VS is set to 800 nsec to 1500 nsec. In this embodiment, period T21 is set to about 1000 nsec.

(Period T31)

At time t31, switching element Q12 is turned on. Then, charges start moving from scan electrodes SC1 to SCn to capacitor C10 through inductor L10, diode D12, and switching element Q12 and thus the voltage of scan electrodes SC1 to SCn starts falling down. As described above, in this embodiment, the resonance period of inductor L10 and interelectrode capacitance Cp is set to about 1100 nsec. In the first sustain pulse, the falling time of the sustain pulse applied to scan electrodes SC1 to SCn, that is, period T31 from time t31 to time t4, is set to about 550 nsec which is ½ of the resonance period.

(Period T4)

At time t4 when about ½ of the resonance period passes from time t31, switching element Q14 is turned on. Then, since scan electrodes SC1 to SCn are directly grounded through switching element Q14, scan electrodes SC1 to SCn are clamped to 0 (V).

In this way, the rising time and the falling time of the first sustain pulse is set to about 550 nsec, which is about ½ of 1100 nsec which is the resonance period of inductor L10 and interelectrode capacitance Cp.

Next, the second sustain pulse having the steeper rising slope than that of the first sustain pulse will be described. FIG. 14 is a waveform diagram illustrating the second sustain pulse according to the embodiment of the invention.

(Period T12)

At time t1, switching element Q11 is turned on. Then, charges start moving from power collecting capacitor C10 to scan electrodes SC1 to SCn through switching element Q11, diode D11, and inductor L10 and thus the voltage of scan electrodes SC1 to SCn starts rising up. In the second sustain pulse, the rising time of the sustain pulse applied to scan electrodes SC1 to SCn, that is, period T12 from time t1 to time t22, is set to about 300 nsec which is smaller than ½ of the resonance period.

(Period T22)

At time t22, switching element Q13 is turned on. Then, since scan electrodes SC1 to SCn are connected directly to power source VS through switching element Q13, scan electrodes SC1 to SCn are clamped to voltage Vs to generate the sustain discharge. In the second sustain pulse, period T22 is set to be longer than T 21 by the rising time reduced from that of the first sustain pulse, that is, about 1150 nsec, and thus the pulse width from the rising to the falling in the first sustain pulse and the second sustain pulse is not changed.

Operations in period T31 and period T4 of the second sustain pulse are equal to those of the first sustain pulse and thus description thereof will be omitted.

In this way, the rising time of the second sustain pulse is about 300 nsec, which is smaller than that of the first sustain pulse, and thus the second sustain pulse has the steeper rising slope than that of the first sustain pulse.

Hitherto, operations of the sustain pulse generating circuit for generating the first sustain pulse and the second sustain pulse according to this embodiment have been described. As described above, by controlling the time for maintaining the switching elements (specifically, switching elements Q11 and Q21) for controlling the application of a voltage to the display electrode pairs from the power recovery section in the ON state, two kinds of sustain pulses having different rising slopes are generated.

Although the sub field configuration in which the first SF is set to the overall cell initializing sub field and the second SF to the tenth SF are set to the selective initializing sub field has been described in the embodiment of the invention, the invention is not limited to the sub field configuration, but may have another sub field configuration.

Although it has been described in this embodiment that the second sustain pulse is applied to scan electrodes SC1 to SCn continuously 5 times at the end of the sustain period, the invention is not limited to the numerical value, but the number of times can be set preferably to the optimal number depending on the characteristics of the panel or the like. In periods other than the above-mentioned period, only the first sustain pulse may be applied to scan electrodes SC1 to SCn and sustain electrodes SU1 to SUn, or the first sustain pulse and the second sustain pulse may be periodically alternately applied to the electrodes, for example, at a predetermined ratio, for example, 2:1.

Although it has been described in this embodiment that the fifth SF or later which is the sub field whose brightness weight is equal to or greater than a predetermined value (for example, 10) is the target sub field to which the second sustain pulse is continuously applied, this is only an example of a configuration of determining the sub fields to which the second sustain pulse is applied on the basis of the total number of sustain pulses in one sub field period. In this embodiment, the sub fields to which the second sustain pulse is applied is determined on the basis of the total number of sustain pulses in one sub field period and, for example, the sub fields to which the total number of sustain pulses in one sub field period is 50 or more is set as the sub fields to which the second sustain pulse is applied. Accordingly, for example, when the brightness magnification is made to vary on the basis of the brightness of a display image, the sub fields to which the second sustain pulse is applied can be changed on the basis of the brightness magnification, thereby making a control based on the brightness of the display image.

Although it has been described in this embodiment that the same inductor is used for power supply and for power collecting, the invention is not limited to such a configuration, but plural inductors having different inductance can be switched for use. In this configuration, for example, when the rising or the falling of the sustain pulse gets faster, the inductor having a higher resonance frequency can be driven.

In the invention, the voltage waveform of the sustain pulse at the end of the sustain period is not limited to the above-mentioned voltage waveform.

Although it has been described in this embodiment that the partial pressure of xenon in the discharging gas is 10%, the partial pressure of xenon may be a different value and in this case, the generation ratio of the respective sustain pulses can be set based on the panel.

In this embodiment, the 50-inch panel with 1080 display electrode pairs is used to make the experiments. The specific numerical values in this embodiment are based on the panel and are only examples. This embodiment is not limited to the numerical values, but the optimal values can be preferably set depending on the characteristics of the panel or specifications of the plasma display device.

As described above, in this embodiment, the second sustain pulse having the steeper rising slope is applied to only one of electrodes of the display electrode pair continuously a predetermined number of times at the end of the sustain period of a predetermined sub field. Thus, the predetermined number of times is twice or more. For example, the second sustain pulse whose rising time is set to about 300 nsec is applied to scan electrodes SC1 to SCn continuously 5 times at the end of the sustain periods of the seventh SF to the ninth SF. Accordingly, a strong sustain discharge can be generated at the last of the sustain period to form sufficient wall charges in the discharge cells, the address discharge can be stably generated without increasing the voltage necessary for the address in the address period of the subsequent sub field, and the discharge intensity can be controlled not to cause address failure due to the charge reduction in the adjacent discharge cells.

### INDUSTRIAL APPLICABILITY

The invention is useful as a plasma display device and a panel driving method, since it is possible to generate a stable address discharge without increasing a voltage necessary for the address discharge even in a high-precision and high-brightness panel.

1. A plasma display device comprising:
a plasma display panel that has a plurality of discharge cells each having a display electrode pair of a scan electrode and a sustain electrode,
wherein a plurality of sub fields is set in one field period, each of the sub fields having an initializing period for generating an initializing discharge in the discharge cell, an address period for generating an address discharge in the discharge cell and a sustain period for applying a sustain pulse to the display electrode pairs to generate a sustain discharge in the discharge cell; and
a sustain pulse generating circuit for generating the sustain pulse with a variable rising slope,
wherein the sustain pulse generating circuit generates at least two kinds of sustain pulses having different rising slopes and applies the sustain pulse having the steeper rising slope to only one of electrodes of the display electrode pair continuously twice or more at an end of the sustain period.

2. The plasma display device according to claim 1, wherein the sustain pulse generating circuit applies the sustain pulse having the steeper rising slope to only one of electrodes of the display electrode pair continuously twice or more at the end of the sustain period in at least one sub field of the plurality of sub fields.

3. The plasma display device according to claim 2, wherein at least one of the sub fields is a sub field other than the sub field just before the sub field in which the initializing discharge is generated in all the discharge cells.

4. The plasma display device according to claim 2, wherein at least one of the sub fields is a sub field other than the final sub field in one field period.

5. The plasma display device according to claim 1, wherein one electrode of the display electrode pair is the scan electrode.

6. A plasma-display-panel driving method of driving a plasma display panel that has a plurality of discharge cells each having a display electrode pair of a scan electrode and a sustain electrode,
wherein a plurality of sub fields is set in one field period, each of the sub fields having an initializing period for generating an initializing discharge in the discharge cells, an address period for generating an address discharge in the discharge cells, and a sustain period for applying a sustain pulse to the display electrode pairs to generate a sustain discharge in the discharge cells, the method comprising:
applying to the display electrode pair by using at least two kinds of sustain pulses having different rising slopes; and
wherein the sustain pulse having the steeper rising slope is applied to only one of electrodes of the display electrode pair continuously twice or more at an end of the sustain period.

7. The plasma-display-panel driving method according to claim 6, wherein the sustain pulse having the steeper rising slope is applied to only one of electrodes of the display electrode pair continuously twice or more at the end of the sustain period in at least one sub field of the plurality of sub fields.
